(19) United States
(12) Patent Application Publication
(10) Pub. No.: US 2011/0195750 A1
(43) Pub. Date: Aug. 11, 2011

(54) APPLICATION EXPANDING DOCKING APPARATUS AND ELECTRICAL SYSTEM THEREOF

(75) Inventors: WEI-CHENG WANG, TAIPEI COUNTY (TW); CHIN-LEE TENG, TAIPEI CITY (TW)

(73) Assignee: ELITEGROUP COMPUTER SYSTEMS CO., LTD., TAIPEI CITY (TW)

(21) Appl. No.: 12/769,810

(22) Filed: Apr. 29, 2010

(30) Foreign Application Priority Data
Feb. 5, 2010 (TW) 99202409

(51) Int. Cl. H04B 1/38

(52) U.S. Cl. 455/558

(57) ABSTRACT

An application expanding docking apparatus is disclosed. The apparatus includes a processing unit, a storage connection interface, a subscriber identity module connection interface, and a communication interface. The storage connection interface is coupled with the processing unit, for connecting a storage unit. The subscriber identity module connection interface is coupled with the processing unit, for connecting a subscriber identity module card. Through the connection of the communication interface, the electrical devices may access and operate upon the storage unit and the subscriber identity module card.

### BACKGROUND OF THE INVENTION

1. Field of the Invention

The present invention relates to an application expanding docking apparatus, and more particularly to an application expanding docking apparatus which at least includes a subscriber identity module and a storage unit.

2. Description of the Related Art

As more and more hardware (electrical equipment) in compliance with different standards is available, how to enable electrical devices to fully utilize the hardware with different specifications without making drastic change to the electrical devices becomes more and more important.

For example, there are some different type specifications of memory cards for a digital camera, such as Secure Digital (SD) memory card, Memory Stick (MS card), and Compact Flash card (CF card). And the digital camera designed to utilize the SD memory card could not access the MS card when the necessity arises.

Moreover, the electrical devices such as a mobile phone may have to access more than one subscriber identity module (SIM) card while the currently available mobile phones may need certain modifications in hardware or even reboot of the mobile phones before accessing and operating upon the additional SIM card.

### SUMMARY OF THE INVENTION

Because of the aforementioned problems, the present invention provides an application expanding docking apparatus. The apparatus has several application connection interfaces, such as memory card connection interface and subscriber identity module (SIM) connection interface. And the apparatus utilizes a Universal Serial Bus (USB) or a Bluetooth interface to communicate with an electrical device, so that the electrical device may communicate with electrical equipments connected to the apparatus.

For achieving the mentioned purposes, according to one embodiment of the present invention, an application expanding docking apparatus is disclosed. The apparatus includes a processing unit, a storage connection interface, a subscriber identity module connection interface, and a communication interface.

The processing unit of the apparatus is for processing data and signals. The storage connection interface is coupled with the processing unit, for connecting a storage unit. The storage unit may be a Secure Digital (SD) memory card, a Memory Stick (MS card), a Compact Flash card (CF card), or any other types of memory cards, for storing data. And the subscriber identity module connection interface is coupled with the processing unit, for connecting a subscriber identity module (SIM) card.

The communication interface is coupled with the processing unit and could be a Bluetooth interface or a Universal Serial Bus (USB) interface, for communicating with the electrical device. Therefore, the electrical device may access the storage unit and the subscriber identity module card through the communication interface.

Additionally, the application expanding docking apparatus may further include an identity authentication unit, a power supply unit, a display unit, and a sound emitting unit. The identity authentication unit is coupled with the processing unit, for receiving an identity authentication data from the electrical device, such as an identity code, a fingerprint data, a voiceprint data, an iris data, or a retina data. And the identity authentication unit is configured to identify an identity according to the identity authentication data.

The electrical device may communicate with the application expanding docking apparatus through the USB or Bluetooth interface, so as to access the electrical equipments connected to the application expanding docking apparatus such as the additional memory cards or additional SIM cards. Therefore, the application expanding docking apparatus may facilitate a functional expansion for the electrical devices without necessity of modification in the hardware or reboot of the electrical devices.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a schematic diagram of the application expanding docking apparatus according to one embodiment of the present invention;

FIG. 2 is a block diagram of the application expanding docking apparatus according to one embodiment of the present invention;

FIG. 3 is a schematic device diagram of the application expanding docking apparatus according to one embodiment of the present invention;

FIG. 4 is a schematic device diagram of the application expanding docking apparatus according to another embodiment of the present invention;

FIG. 5 is a schematic device diagram of the application expanding docking apparatus according to another embodiment of the present invention;

FIG. 6 is a flow chart of a process of enabling a functional expansion by utilizing the application expanding docking apparatus according to one embodiment of the present invention; and

FIG. 7 is a flow chart of connecting mobile phone and the application expanding docking apparatus according to another embodiment of the present invention.

### DETAILED DESCRIPTION OF THE PREFERRED EMBODIMENTS

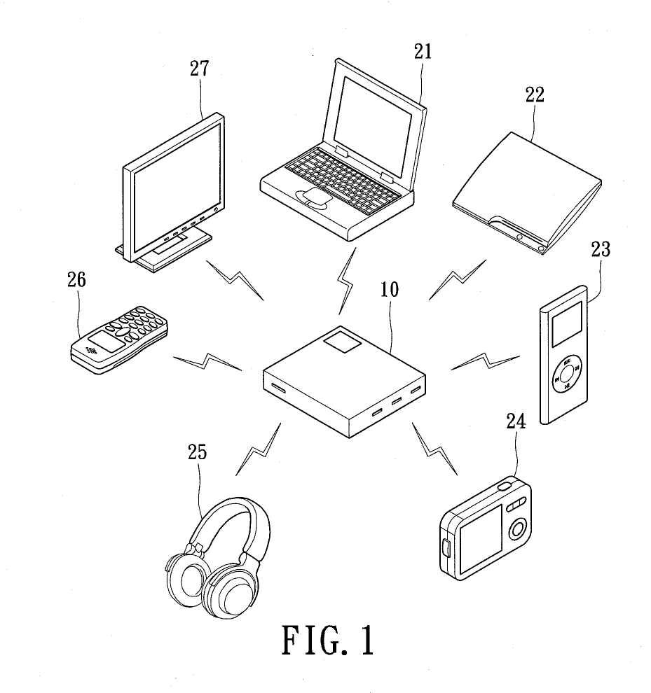

Please refer to FIG. 1, which is a schematic diagram of the application expanding docking apparatus 10 according to one embodiment of the present invention. The apparatus 10 communicates with at least one electrical device through a communication interface, so that the electrical device connected to the apparatus 10 may have additional functions as the apparatus 10 is connected to additional electrical equipments. The electrical devices may be a notebook computer 21, a game station 22, a digital audio player 23, a digital camera 24, a wireless earphone 25, a mobile phone 26, or a digital television 27.

In one implementation, the electrical equipment is a subscriber identity module card (SIM card). When more than one SIM card would be used by the same mobile phone 26, at least one SIM card may be placed at the application expanding docking apparatus 10. And because the mobile phone 26 may be equipped with a built-in Bluetooth module or a Universal Serial Bus (USB) port the apparatus 10 may connect with the mobile phone 26 via the Bluetooth module and the USB port. Therefore, the mobile phone 26 may access the SIM card placed at the apparatus 10 without any modification in the hardware of the mobile phone 26.

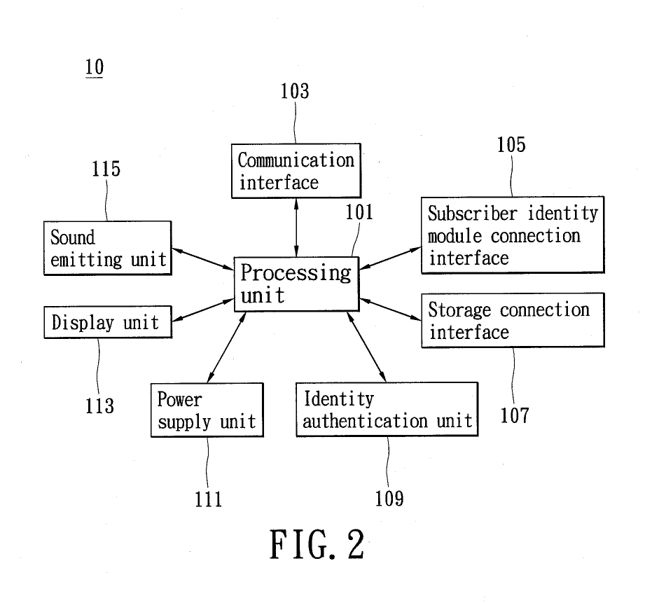

Please refer to FIG. 2, which is a block diagram of the application expanding docking apparatus 10 according to one embodiment of the present invention. The apparatus 10 has a processing unit 101, a communication interface 103, a subscriber identity module (SIM) connection interface 105, and a storage connection interface 107.

As described above, the apparatus 10 communicates with the electrical devices through the communication interface 103. The communication interface 103 may be a Bluetooth interface or a Universal Serial Bus (USB) interface.

For example, the communication interface 103 can be a built-in Bluetooth integrated circuit (IC), which is configured to establish the wireless connection between the apparatus 10 and electrical devices by a process of “pairing”. Or, the communication interface 103 can be a USB port (or plug) through which the apparatus 10 may communicate with the electrical devices by transmission lines or after being plug into the electrical devices.

The SIM connection interface 105 is coupled to the processing unit 101, for connecting the additional SIM card of mobile phone. In other words, the mobile phone may access the additional SIM card plugged into the SIM connection interface of the apparatus 10 through the communication interface 103. Thus, the apparatus 10 may facilitate a functional expansion for the mobile phone by causing the mobile phone to access and operate upon the additional SIM card.

The storage connection interface 107 is coupled with the processing unit 101. In one implementation, the storage connection interface 107 is a Secure Digital memory card (SD card) connection interface, a Memory Stick (MS) card connection interface, or a Compact Flash card (CF card) connection interface. Similarly, through the communication interface 103, the memory cards connected to the apparatus 10 may be accessed by the electrical devices such as a digital camera, a notebook computer, a mobile phone, or a digital audio player. It is worth noting that the apparatus 10 is capable of providing several slots compatible with several standards, enabling the electrical devices connected to the apparatus 10 to be in connection with additional electrical equipments. In other words, the apparatus 10 may facilitate another functional expansion by causing the mobile phone to access and operate upon the additional electrical equipments such as the storage unit connected to the apparatus 10.

Additionally, the apparatus 10 may further includes an identity authentication unit 109, a power supply unit 111, a display unit 113, and a sound emitting unit 115.

The identity authentication unit 109 is coupled with the processing unit 101, for receiving an identity authentication data from the electrical devices. After receiving the identity authentication data, the identity authentication unit 109 compares the received identity authentication data with the individual data previously stored in the identity authentication unit 109. Accordingly, the identity authentication unit 109 may determine whether the electrical device connected could utilize the electrical equipments connected to the apparatus 10.

Specifically, the identity authentication data may be an identity code, a voiceprint data, a fingerprint data, a retina data, an iris data, or other data which may represent the identity of an individual. And, the identity authentication data may be captured by the electrical devices via an identity capturing module (not shown), or stored in the electrical devices in advance. As mentioned, the identity authentication data is sent to the identity authentication unit 109 through the communication interface 103 when the electrical equipments connected to the apparatus 10 are to be utilized.

Moreover, the power supply unit 111 is coupled with the processing unit 101, for providing an electrical power to the apparatus 10. The display unit 113 is for displaying messages, such as who's using the apparatus 10, how many electrical devices are connecting, or data transmission rates. The sound emitting unit 115 emits sounds for purposes such as warning when errors occur.

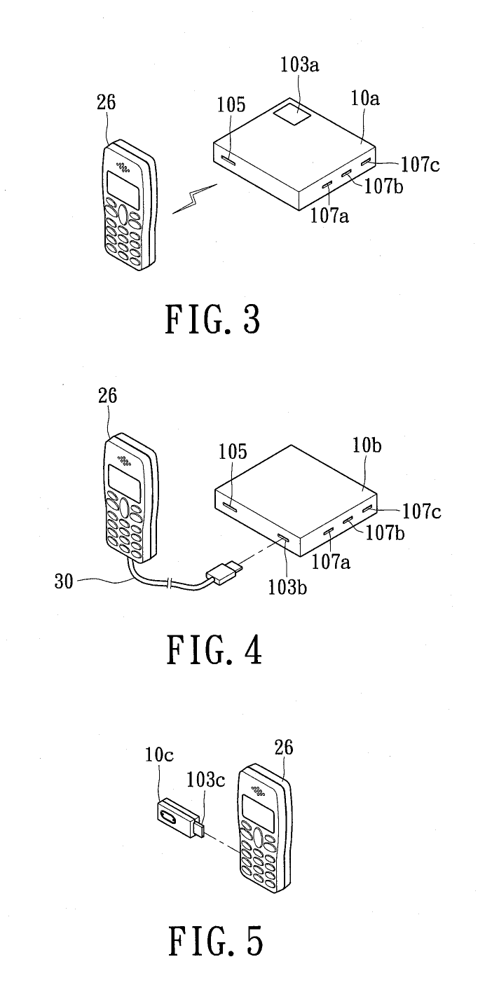

Please refer to FIG. 3, which is a schematic device diagram of the application expanding docking apparatus 10a according to one embodiment of the present invention. In this embodiment, the apparatus 10a is a docking station, and the communication interface 103a is a Bluetooth interface. The Bluetooth interface communicates with the mobile phone 26 wirelessly. As mentioned, the SIM connection interface 105 is for connecting additional SIM cards. The storage connection interface 107a, 107b, and 107c are SD card slot, CF card slot, and MS card slot, respectively. Thus, the mobile phone 26 is capable of connecting to multiple storage devices for expanding the storage capability without any modification to the hardware of the mobile phone 26.

Please refer to FIG. 4, which is a device diagram of the application expanding docking apparatus 10b according to another embodiment of the present invention. The difference between FIG. 3 and FIG. 4 is that the communication interface 103b of the apparatus 10b is a USB interface. Through a transmission line 30, the mobile phone 26 can access the additional hardware resources connected to the apparatus 10b.

And please refer to FIG. 5, which is one of the best modes of the present invention. FIG. 5 discloses a schematic device diagram of the application expanding docking apparatus according to one embodiment of the present invention. The application expanding docking apparatus 10c can be a USB dongle. The communication interface 103c is a USB plug directly connected with the mobile phone 26. Alternatively, the apparatus 10c is a thin card connected with the mobile phone 26, so that the apparatus 10c could always remain connected with the mobile phone 26.

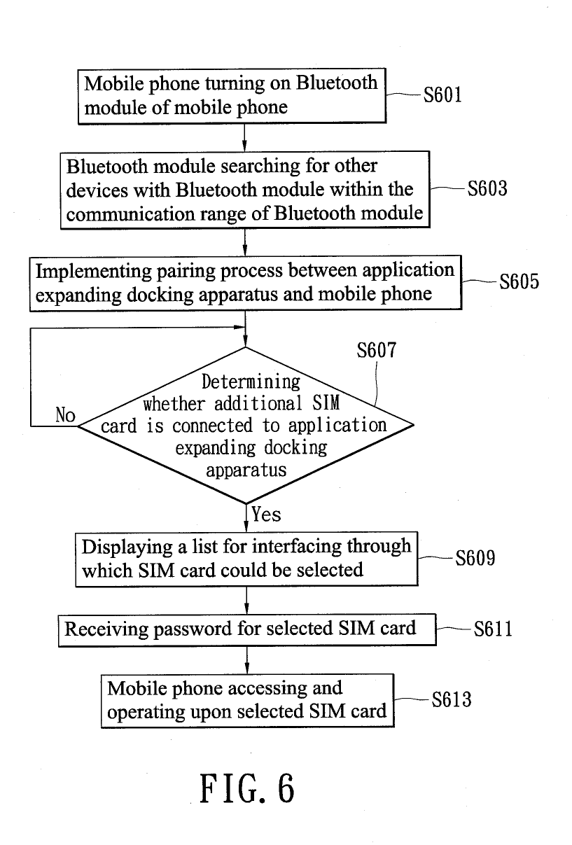

FIG. 6 is a flow chart of a process of enabling a functional expansion of the electrical device by utilizing the application expanding docking apparatus according to one embodiment of the present invention. In this embodiment, the electrical device is the mobile phone 26, and the communication interface is the Bluetooth interface. The steps include: the mobile phone 26 is configured to turn on a built-in Bluetooth module (S601). The Bluetooth module searches other devices with the Bluetooth module within the communication range of the Bluetooth module (S603). If the application expanding docking apparatus 10 is within the communication range of the Bluetooth module, the “pairing” process between the mobile phone 26 and the apparatus 10 may be starting (S605). The process further includes determining whether there is an additional SIM card connected to the SIM connection interface 105 (S607).

If the additional SIM card is connected, the mobile phone 26 then displays a list for interfacing through which the SIM cards including the additional SIM card connected to the SIM connection interface may be selected (S609). Upon a receipt of a signal indicative of a selection of the SIM card, the mobile phone 26 may require an input of password of the selected SIM card (S611). If the inputted password is correct, the mobile phone 26 may access and operate upon the selected SIM card (S613).

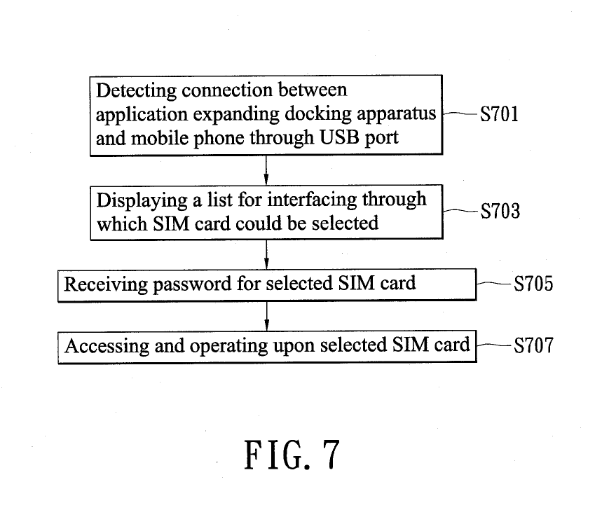

Please refer to FIG. 7, which is a flow chart of a process of connecting the mobile phone 26 to the application expanding docking apparatus 10 through the USB port according to one embodiment of the present invention. The process includes: detecting the connection between the apparatus 10 and the mobile phone 26 through the USB port (S701). The mobile phone 26 displays a list for interfacing through which the SIM card could be selected (S703). Then the mobile phone 26 receives the password for the selected SIM card (S705). If the password is correct, the mobile phone 26 may access and operate upon the selected SIM card (S707).

As described above, the application expanding docking apparatus according to the present invention may facilitate a functional expansion for the electrical devices connected to the apparatus through a communication interface such as the Bluetooth interface or the USB interface.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. An application expanding docking apparatus for facilitating a functional expansion for an electrical device connected to the application expanding docking apparatus, comprising:
a processing unit for processing data and signals;
a subscriber identity module connection interface coupled with the processing unit, for connecting a subscriber identity module card; and
a communication interface coupled with the processing unit, for communicating with the electrical device;
wherein the electrical device is connected with the subscriber identity module card through the communication interface.

2. The apparatus as in claim 1, wherein the communication interface is connected with the electrical device wirelessly.

3. The apparatus as in claim 2, wherein the communication interface is a Bluetooth interface.

4. The apparatus as in claim 1, wherein the communication interface is connected with the electrical device through a transmission line,

5. The apparatus as in claim 4, wherein the communication interface is a Universal Serial Bus (USB) interface.

6. The apparatus as in claim 1, further comprising:
a storage connection interface coupled with the processing unit, for connecting a storage unit.

7. The apparatus as in claim 6, wherein the electrical device can access the storage unit through the communication interface.

8. The apparatus as in claim 6, wherein the storage connection interface is a Secure Digital memory card connection interface.

9. The apparatus as in claim 6, wherein the storage connection interface is a Compact Flash card connection interface.

10. The apparatus as in claim 6, wherein the storage connection interface is a Memory Stick connection interface.

11. The apparatus as in claim 1, further comprising:
an identity authentication unit coupled with the processing unit, for receiving an identity authentication data from the electrical device.

12. The apparatus as in claim 11, wherein the identity authentication data is an identity code, a voiceprint data, a fingerprint data, an iris data, or a retina data.

13. An electrical system, comprising:
an application expanding docking apparatus, including:
a processing unit, for processing data and signals;
a subscriber identity module connection interface coupled with the processing unit, for connecting a subscriber identity module card; and
a communication interface coupled with the processing unit; and
an electrical device connected with the application expanding docking apparatus through the communication interface.

14. The system as in claim 13, wherein the communication interface is connected with the electrical device wirelessly.

15. The system as in claim 14, wherein the communication interface is Bluetooth interface.

16. The system as in claim 13, wherein the communication interface is connected with the electrical device through a transmission line.

17. The system as in claim 16, wherein the communication interface is a Universal Serial Bus (USB) interface.

18. The system as in claim 13, wherein the application expanding docking apparatus further includes:
a storage connection interface coupled with the processing unit, for connecting a storage unit.

19. The system as in claim 13, wherein the application expanding docking apparatus further includes:
an identity authentication unit coupled with the processing unit, for receiving an identity authentication data sent from the electrical device.

20. The system as in claim 13, wherein the electrical device is a mobile phone.
